(19) United States
(12) Patent Application Publication
(10) Pub. No.: US 2026/0229812 A1
(43) Pub. Date: Aug. 6, 2026

(54) MALE CONNECTOR AND CONNECTOR ASSEMBLY

(71) Applicants: KUNSHAN AMPHENOL ZHENGRI ELECTRONICS CO., LTD., Kunshan City, Jiangsu Province (CN); AMPHENOL LTW TECHNOLOGY CO., LTD., New Taipei City (TW)

(72) Inventors: Kun-Te KO, New Taipei City (TW); Chia-Nan HO, New Taipei City (TW); Kuo-Wei HUANG, New Taipei City (TW)

(21) Appl. No.: 19/083,709

(22) Filed: Mar. 19, 2025

(30) Foreign Application Priority Data
Feb. 6, 2025 (TW) 114104414

(51) Int. Cl. H01R 13/52; H01R 13/627

(52) U.S. Cl. CPC H01R 13/5219; H01R 13/6277

(57) ABSTRACT

A male connector is used to plug in a female connector defining a plugging hole and a positioning slot and includes an outer shell, a plug-in portion and a plurality of conductors inserted into the plug-in portion. The plug-in portion has a first outer periphery, a second outer periphery smaller than the first outer periphery, a positioning structure arranged on the first outer periphery, and a ring flange arranged on the second outer periphery. The first outer periphery is located between the outer shell and the second outer periphery. When the male connector plugs in the female connector, the plug-in portion and at least part of the conductors are accommodated in the plugging hole, the positioning structure is fixed to the positioning slot, the ring flange elastically bends toward the outer shell and elastically abuts against an inner wall of the plugging hole to improve waterproof effect.

### BACKGROUND

### Technical Field

The present disclosure relates to connector field, particularly to a male connector and a connector assembly.

### Description Of Related Art

Connector assemblies are widely used in various industrial, electronic and technological fields. There are many types and forms of connector assemblies available for consumers to choose from according to different needs. The connector assembly mainly includes a male connector and a female connector that may be plugged into each other. When the male connector and the female connector are plugged into each other, the circuits electrically connected thereof may together form a path to transfer current or signal. In addition, in order to prevent the male connector and the female connector from loosening after being plugged to affect an electrical connection effect, most of them are designed with buckles or clamping structures to ensure a connection reliability between the two and to facilitate quick disassembly and assembly.

However, when existing connector assemblies are fastened with buckles, they often wear out easily due to repeated insertion and removal such that the connection reliability and the electrical connection effect between the male connector and the female connector are affected. On the other hand, since existing connector assemblies are fastened with buckles, a gap is still formed between the male connector and the female connector to cause insufficient sealing and waterproofing, such that dust or moisture may easily penetrate and affect the life and reliability of the connector assemblies.

In view of the above, the inventor seeks to overcome the aforementioned drawbacks associated with the current technology and aims to provide an effective solution through extensive researches along with utilization of academic principles and knowledge.

### SUMMARY

The primary objective of the present disclosure is to perform good sealing dustproof and waterproof effect when the male connector is plugging and fastened to the female connector.

To accomplish the aforementioned objective, the present disclosure provides a male connector used to plug in a female connector. The female connector defines a plugging hole and a positioning slot. The positioning slot is located on an inner wall of the plugging hole. The male connector includes an insulating body and a plurality of conductors. The insulating body includes an outer shell and a plug-in portion arranged on an end of the outer shell. The plug-in portion has a first outer periphery, a second outer periphery, a positioning structure and a ring flange. The first outer periphery is located between the outer shell and the second outer periphery. An outer diameter of the first outer periphery is greater than an outer diameter of the second outer periphery. The positioning structure is arranged on the first outer periphery. The ring flange is arranged on the second outer periphery and protrudes from the first outer periphery. At least part of each of the conductors is arranged in the plug-in portion and surrounded by the second outer periphery. When the male connector plugs in the female connector, at least part of the plug-in portion and at least part of the conductors are accommodated in the plugging hole, the positioning structure is fixed to the positioning slot, and the ring flange elastically bends toward the outer shell and elastically abuts against the inner wall of the plugging hole.

Another aspect of the present disclosure provides that the ring flange is gradually contracted and extended from the second outer periphery along a direction away from each of the conductors.

Another aspect of the present disclosure provides that the positioning slot is an annular groove, the positioning structure is an annular convex strip.

Another aspect of the present disclosure provides that the ring flange further protrudes from the positioning structure.

Another aspect of the present disclosure provides that the plug-in portion further has a stopping ring, the first outer periphery is connected between the stopping ring and the second outer periphery, the stopping ring abuts against the female connector when the male connector plugs in the female connector.

To accomplish the aforementioned objective, the present disclosure further provides a connector assembly having a female connector and a male connector. The female connector defines a plugging hole and a positioning slot. The positioning slot is located on an inner wall of the plugging hole. The male connector has a plug-in portion. The plug-in portion has a first outer periphery, a second outer periphery, a positioning structure and a ring flange. The first outer periphery is located on an inner side of the second outer periphery. An outer diameter of the first outer periphery is greater than an outer diameter of the second outer periphery. The positioning structure is arranged on the first outer periphery. The ring flange is arranged on the second outer periphery and protrudes from the first outer periphery. When the male connector plugs in the female connector, at least part of the plug-in portion is accommodated in the plugging hole, the positioning structure is fixed to the positioning slot, and the ring flange elastically bends toward the second outer periphery and elastically abuts against the inner wall of the plugging hole.

Another aspect of the present disclosure provides that the ring flange is gradually contracted and extended from the second outer periphery.

Another aspect of the present disclosure provides that the positioning slot is an annular groove, the positioning structure is an annular convex strip.

Another aspect of the present disclosure provides that the ring flange further protrudes from the positioning structure.

Another aspect of the present disclosure provides that the plug-in portion further has a stopping ring, the first outer periphery is connected between the stopping ring and the second outer periphery, the stopping ring abuts against the female connector when the male connector plugs in the female connector.

In the male connector and the connector assembly of the present disclosure, the first outer periphery and the second outer periphery are formed on the plug-in portion, the first outer periphery is located between the outer shell and the second outer periphery, an outer diameter of the first outer periphery is greater than an outer diameter of the second outer periphery, the positioning structure is arranged on the first outer periphery, and the ring flange is arranged on the second outer periphery and protrudes from the first outer periphery. Therefore, when the male connector plugs in the female connector, the male connector has enough space for the ring flange to deform elastically and bend toward the outer shell, so as to perform good sealing dustproof and waterproof effect and fix the positioning structure to the positioning slot of the female connector to avoid the two from separating.

### BRIEF DESCRIPTION OF THE DRAWINGS

FIG. 1 is an exploded view of the male connector and the female connector of the present disclosure;

FIG. 2 is cross-sectional side view of the male connector and the female connector of the present disclosure before plugging;

FIG. 3 is a cross-sectional side view of the male connector and the female connector of the present disclosure when plugging;

FIG. 4 is a partial exploded view of FIG. 3;

FIG. 5 is a cross-sectional side view of the male connector and the female connector of the present disclosure after plugging; and

FIG. 6 is a partial exploded view of FIG. 5.

### DETAILED DESCRIPTION

It is to be understood that the terms for indicating positions and the location relation, for example “front”, “rear”, “left”, “right”, “front end”, “rear end”, “distal end”, “longitudinal direction”, “lateral direction”, “vertical direction”, “top” and “bottom”, are based on the positions and the location relation disclosed in the drawings, and only used for disclosing the present disclosure and not used for indicating or implying the specified location of the device or the components or the specified structure and operation in certain location, thus the present disclosure is not intended to be limiting.

For example, the terms of “first”, “second”, “third”, “forth” and “fifth” are used for illustrating each unit, component, area, layer and/or part. The component, the unit, the area, the layer and/or the part are not limited by the terms. These terms are only used for separating the element, the assembly, the area, the layer, or the part. Unless being clearly indicated according to the whole specification, the terms for example “the first”, “the second”, “the third”, “the fourth” and “the fifth” are not used for implying the order or sequence.

As used herein and not otherwise defined, the terms "substantially" and "approximately" are used to describe and describe small changes. When used in connection with an event or situation, the terms may include the precise moment at which the event or situation occurs, as well as the event or situation occurring to a close approximation. For example, when combined with a numerical value, the terms may include a range of variation equal to or less than ±5% of the numerical value, such as equal to or less than ±4%, equal to or less than ±3%, equal to or less than ±2%, equal to or less than ±1%, equal to or less than ±0.5%, equal to or less than ±0.1%, or equal to or less than ±0.05%.

The technical contents of the present disclosure will become apparent with the detailed description of embodiments and the accompanied drawings as follows. However, it shall be noted that the accompanied drawings are for illustrative purposes only such that they shall not be used to restrict the scope of the present disclosure.

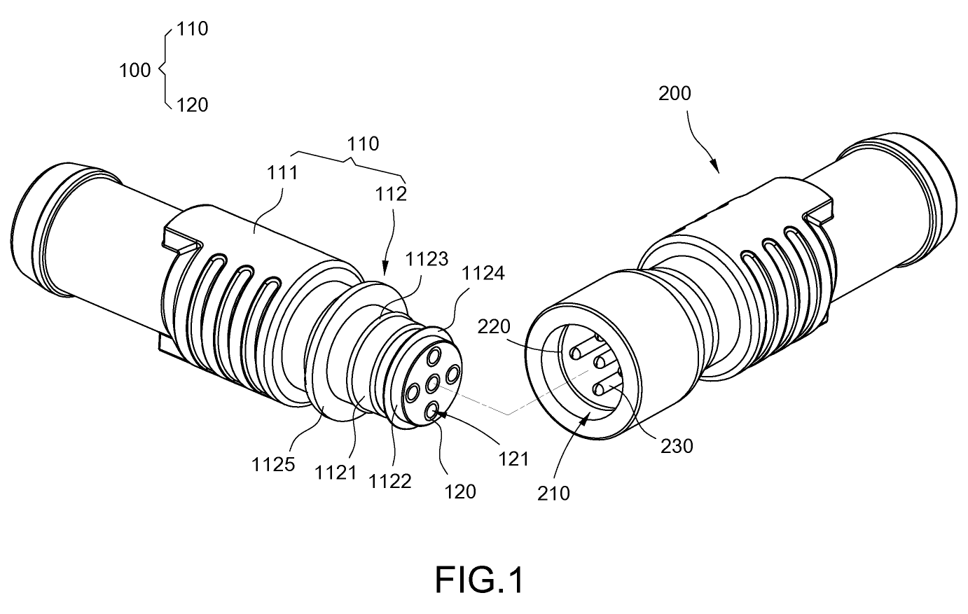

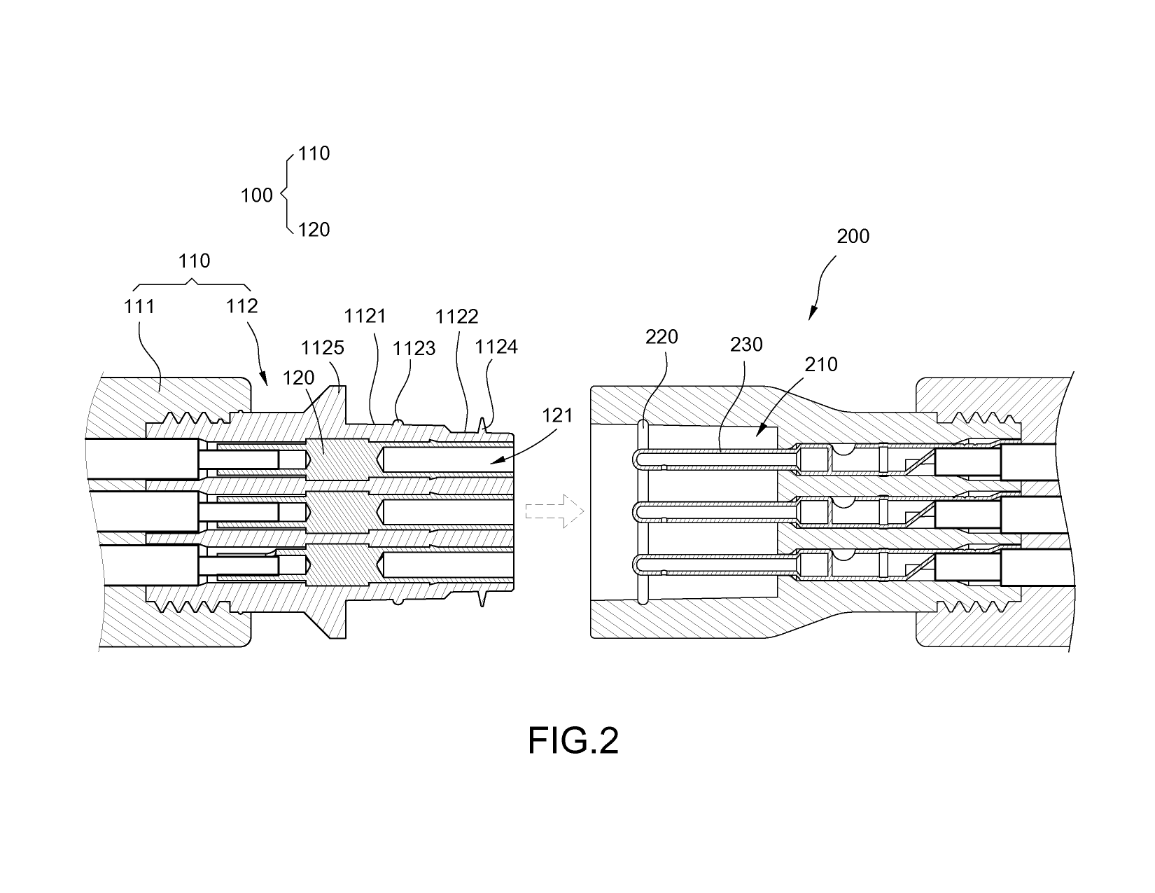

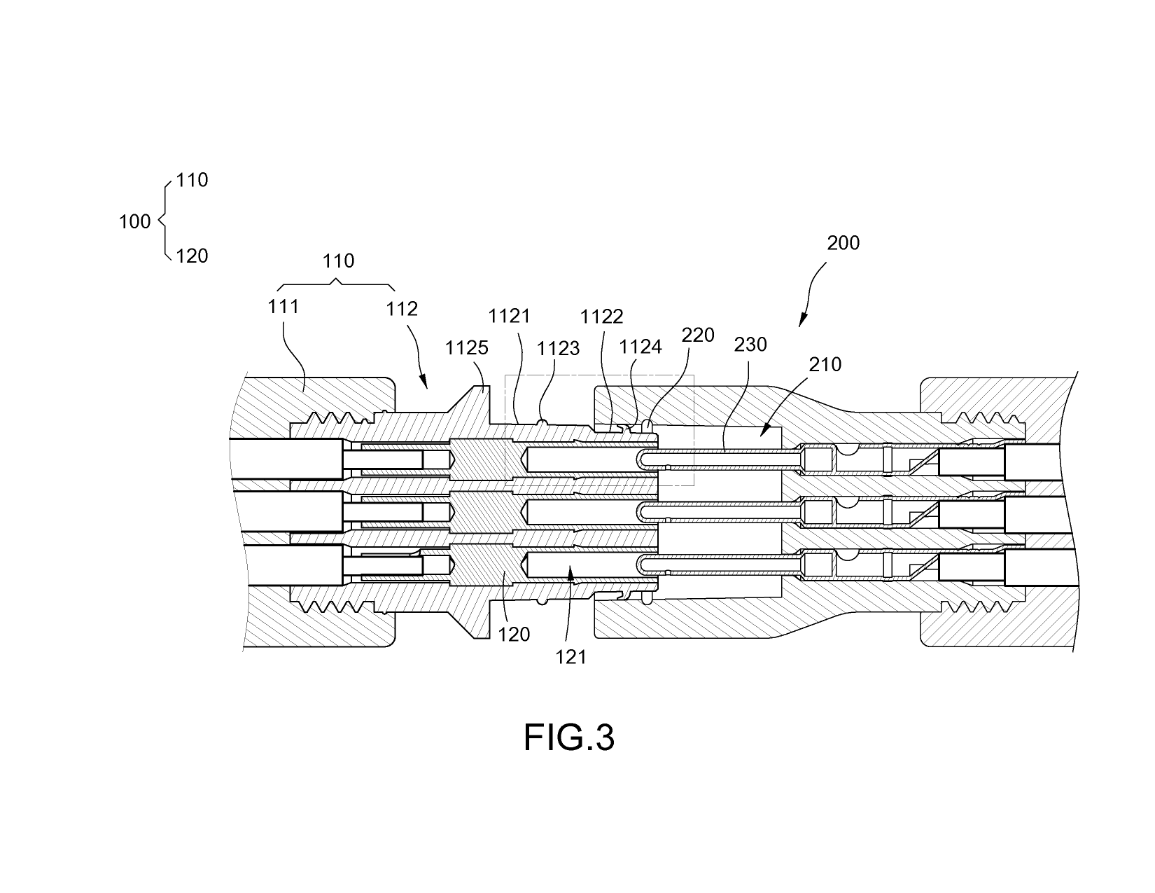

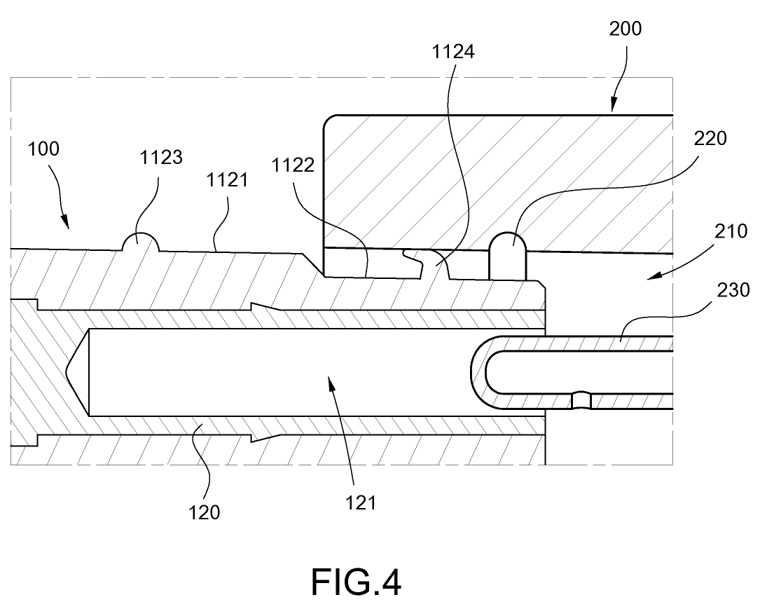

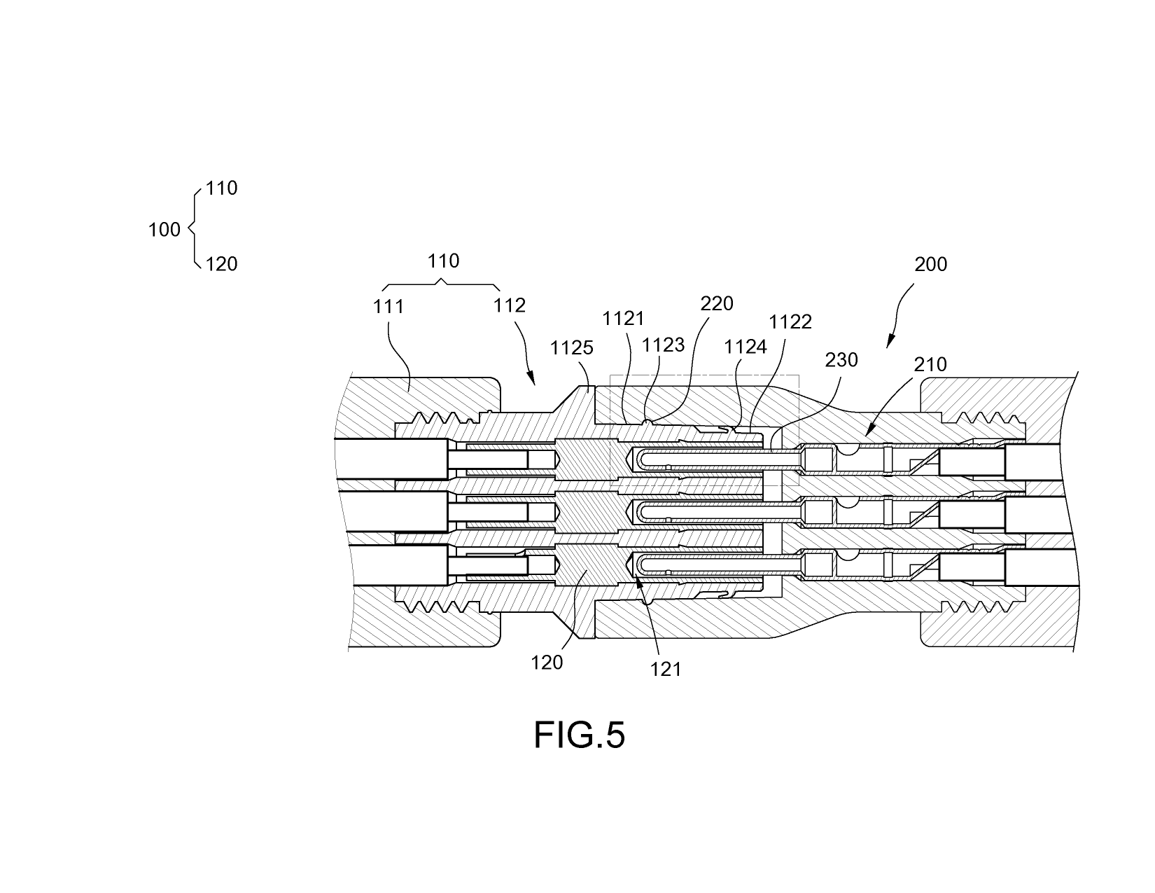

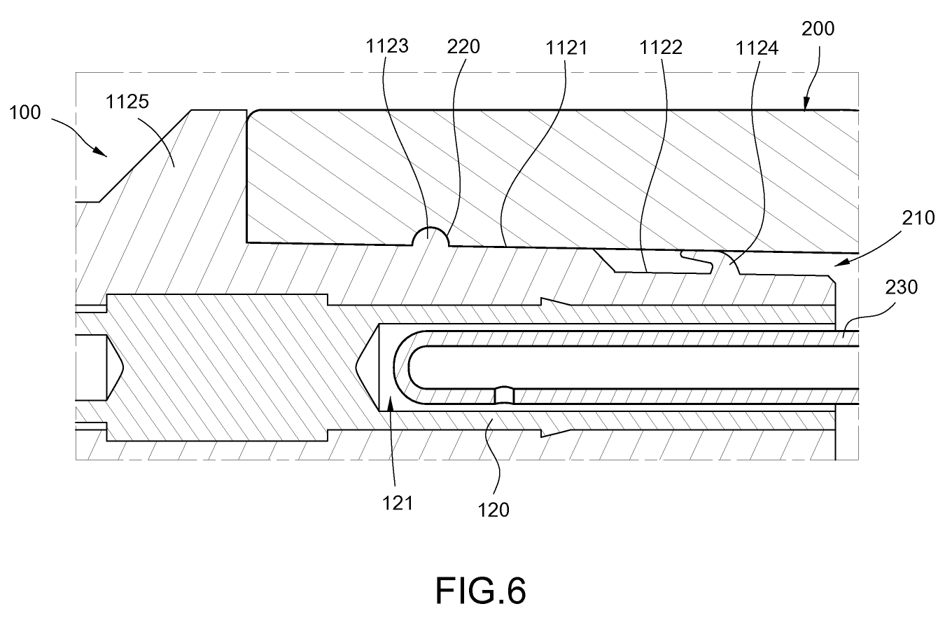

The present disclosure provides a male connector 100 used to plug in and fix to a female connector 200 to perform an electrical connection. Please refer to FIG. 1, FIG. 2, FIG. 3, FIG. 4, FIG. 5, and FIG. 6, the female connector 200 defines a plugging hole 210 and a positioning slot 220. The positioning slot 220 is located on an inner wall of the plugging hole 210. The male connector 100 of the present disclosure includes an insulating body 10 and a plurality of conductors 20.

The insulating body 110 includes an outer shell 111 and a plug-in portion 112. The plug-in portion 112 is arranged on an end of the outer shell 111. In the embodiment, the plug-in portion 112 and the outer shell 111 are assemble in two-part form, but the plug-in portion 112 and the outer shell 111 may also be in a one-piece from in another embodiment according to design process or using need. The plug-in portion 112 mainly has a first outer periphery 1121, a second outer periphery 1122, a positioning structure 1123 and a ring flange 1124. The first outer periphery 1121 is located between the outer shell 111 and the second outer periphery 1122, that is the first outer periphery 1121 and the second outer periphery 1122 are sequentially arranged away from the outer shell 111. An outer diameter of the first outer periphery 1121 is greater than an outer diameter of the second outer periphery 1122. The positioning structure 1123 is arranged on the first outer periphery 1121. The ring flange 1124 is arranged on the second outer periphery 1122 and protrudes from the first outer periphery 1121. In the embodiment, the whole plug-in portion 112 is in a one-piece form, that is the positioning structure 1123 and the ring flange 1124 are directly formed on the first outer periphery 1121 and the second outer periphery 1122 to ensure the structural strength of the positioning structure 1123 and the ring flange 1124, so as to prevent the two detaching from the first outer periphery 1121 and the second outer periphery 1122. However, the present disclosure is not limited to this embodiment. For example, the positioning structure 1123 and the ring flange 1124 may also be fixed to the first outer periphery 1121 and the second outer periphery 1122 by bonding, welding, or locking in other embodiments. In addition, the plug-in portion 112 in the embodiment is made of rubber such that the ring flange 1124 may elastically deform during forcing, but the present disclosure is not limited to this embodiment, as long as the ring flange 1124 is made of an elastic insulating material.

The conductors 120 are made of a material with good conductivity. At least part of each of the conductors 120 is arranged in the plug-in portion 112, and each of the conductors 120 is surrounded by the second outer periphery 1122. In the embodiment, each of the conductors 120 is a hollow cylinder to define a conductive slot 121, a plurality of conductive pins 230 corresponding to each of the conductive slots 121 of the conductors 120 is arranged in the plugging hole 210 of the female connector 200, each of the conductive pins 230 is for each of the conductive slots 121 of the conductors 120 being adapted to sheathe thereon to form electrical connection, but the present disclosure is not limited to this embodiment. For example, the form of each of the conductors 120 may also be a pin for respectively plugging in each of the conductive slots 121 defined in the plugging hole 210 of the female connector 200 to perform the electrical connection. In other words, the present disclosure does not limit each of the conductors 120 of the male connector 100 to be pin form or slot form, the form of each of the conductors 120 may be modified according to different needs.

Therefore, when the male connector 100 plugs in the female connector 200, at least part of the plug-in portion 112 and at least part of the conductors 120 are accommodated in the plugging hole 210, such that the positioning structure 1123 is fixed to the positioning slot 220, and the ring flange 1124 elastically bends toward the outer shell 111 and elastically abuts against the inner wall of the plugging hole 210. In this way, the male connector 100 may not only be plugging in and fixed to the female connector 200, but may also perform good sealing dustproof and waterproof effect through the elastically deformable ring flange 1124.

Details are provided as follows. The ring flange 1124 is gradually contracted and extended from the second outer periphery 1122 along a direction away from each of the conductors 120. In other words, a root of the ring flange 1124 connected to the second outer periphery 1122 is thicker than an end of the ring flange 1124 away from the second outer periphery 1122. Therefore, the male connector 100 may not only strengthen the structural strength of the root of the ring flange 1124, but also reduce the structural strength of the end of the ring flange 1124 such that it is easier to deform elastically. In the embodiment, a cross-sectional shape of the ring flange 1124 is isosceles triangle, but the present disclosure is not limited to this embodiment. For example, the cross-sectional shape of the ring flange 1124 may also be right triangle, trapezoid or other shapes, as long as the ring flange 1124 is gradually contracted and extended from the second outer periphery 1122 along the direction away from each of the conductors 120. In the embodiment, the ring flange 1124 further protrudes from the positioning structure 1123, that is the root of the ring flange 1124 sequentially protrudes from the positioning structure 1123, the first outer periphery 1121, and the second outer periphery 1122, so as to ensure that the ring flange 1124 has enough length to perform elastic deformation and abut against the inner wall of the plugging hole 210. Therefore, the male connector and the female connector may perform good sealing dustproof and waterproof effect.

In addition, the positioning slot 220 in the embodiment is an annular groove, and the positioning structure 1123 is an annular convex strip. In other words, the annular groove of the positioning slot 220 surrounds the inner wall of the female connector 200, and the convex strip of the positioning structure 1123 surrounds the first outer periphery 1121 of the male connector 100. Therefore, the male connector 100 may ensure that the positioning structure 1123 may be fixed to the positioning slot 220 when the male connector 100 plugs into the female connector 200 at any angle. However, the present disclosure is not limited to this embodiment. For example, when the plug-in portion 112 is a rectangular body, the positioning structure 1123 may also be four convex blocks arranged on four side planes of the plug-in portion 112, and the positioning slot 220 may also correspondingly be four concave slots. Therefore, the matching form of the positioning structure 1123 and the positioning slot 220 may be modified according to different needs. In addition, a cross-sectional shape of the positioning slot 220 in the embodiment is inwardly concave arcuate slot, and a cross-sectional shape of the positioning structure 1123 is arc convex such that the positioning structure 1123 may be easily fixed into the positioning slot 220, but the present disclosure is not limited to this embodiment.

Details are provided as follows. The plug-in portion 112 further has a stopping ring 1125. The first outer periphery 1121 is connected between the stopping ring 1125 and the second outer periphery 1122, that is the stopping ring 1125 is located between the outer shell 111 and the first outer periphery 1121. Therefore, when the male connector 100 plugs in the female connector 200, the stopping ring 1125 may abut against the female connector 200 to prevent further insertion of the male connector 100, so as to perform a stopping and limiting effect.

Please refer to FIG. 1, FIG. 2, FIG. 3, FIG. 4, FIG. 5, and FIG. 6. The present disclosure further provides a connector assembly having the male connector 100 and the female connector 200. The male connector 100 may plug in and be fixed to the female connector 200 to perform the electrical connection.

The female connector 200 defines the plugging hole 210 and the positioning slot 220. The positioning slot 220 is located on the inner wall of the plugging hole 210. The male connector 100 has the plug-in portion 112. The plug-in portion 112 has the first outer periphery 1121, the second outer periphery 1122, the positioning structure 1123 and the ring flange 1124. The first outer periphery 1121 is located between the outer shell 111 and the second outer periphery 1122. The outer diameter of the first outer periphery 1121 is greater than the outer diameter of the second outer periphery 1122. The positioning structure 1123 is arranged on the first outer periphery 1121. The ring flange 1124 is arranged on the second outer periphery 1122 and protrudes from the first outer periphery 1121.

Therefore, when the male connector 100 plugs in the female connector 200, at least part of the plug-in portion 112 is accommodated in the plugging hole 210, such that the positioning structure 1123 is fixed to the positioning slot 220, and the ring flange 1124 elastically bends toward the second outer periphery 1122 and elastically abuts against the inner wall of the plugging hole 210. In this way, the male connector 100 may not only be plugged in and fixed to the female connector 200, but may also perform good sealing dustproof and waterproof effect through the elastically deformable ring flange 1124.

Details are provided as follows. The male connector 100 of the present disclosure includes the insulating body 110 and the conductors 120.

The insulating body 110 includes the outer shell 111 and the plug-in portion 112. The plug-in portion 112 is arranged on the end of the outer shell 111. In the embodiment, the plug-in portion 112 and the outer shell 111 are assemble in two-part form, but the plug-in portion 112 and the outer shell 111 may also be in a one-piece from in another embodiment according to design process or using need. The plug-in portion 112 mainly has the first outer periphery 1121, the second outer periphery 1122, the positioning structure 1123 and the ring flange 1124. The first outer periphery 1121 is located between the outer shell 111 and the second outer periphery 1122, that is the first outer periphery 1121 and the second outer periphery 1122 are sequentially arranged away from the outer shell 111. The outer diameter of the first outer periphery 1121 is greater than the outer diameter of the second outer periphery 1122. The positioning structure 1123 is arranged on the first outer periphery 1121. The ring flange 1124 is arranged on the second outer periphery 1122 and protrudes from the first outer periphery 1121. In the embodiment, the whole plug-in portion 112 is in a one-piece form, that is the positioning structure 1123 and the ring flange 1124 are directly formed on the first outer periphery 1121 and the second outer periphery 1122 to ensure the structural strength of the positioning structure 1123 and the ring flange 1124, so as to prevent the two detaching from the first outer periphery 1121 and the second outer periphery 1122. However, the present disclosure is not limited to this embodiment. For example, the positioning structure 1123 and the ring flange 1124 may also be fixed to the first outer periphery 1121 and the second outer periphery 1122 by bonding, welding, or locking in other embodiments. In addition, the plug-in portion 112 in the embodiment is made of rubber such that the ring flange 1124 may elastically deform during forcing, but the present disclosure is not limited to this embodiment, as long as the ring flange 1124 is made of an elastic insulating material.

The conductors 120 are made of a material with good conductivity. At least part of each of the conductors 120 is arranged in the plug-in portion 112, and each of the conductors 120 is surrounded by the second outer periphery 1122. In the embodiment, each of the conductors 120 is a hollow cylinder to define the conductive slot 121, the plurality of conductive pins 230 corresponding to each of the conductive slots 121 of the conductors 120 is arranged in the plugging hole 210 of the female connector 200, each of the conductive pins 230 is for each of the conductive slots 121 of the conductors 120 being adapted to sheathe thereon to form electrical connection, but the present disclosure is not limited to this embodiment. For example, the form of each of the conductors 120 may also be the pin for respectively plugging in each of the conductive slots 121 defined in the plugging hole 210 of the female connector 200 to perform the electrical connection. In other words, the present disclosure does not limit each of the conductors 120 of the male connector 100 to be pin form or slot form, the form of each of the conductors 120 may be modified according to different needs.

Details are provided as follows. The ring flange 1124 is gradually contracted and extended from the second outer periphery 1122 along a direction away from each of the conductors 120. In other words, the root of the ring flange 1124 connected to the second outer periphery 1122 is thicker than the end of the ring flange 1124 away from the second outer periphery 1122. Therefore, the male connector 100 may not only strengthen the structural strength of the root of the ring flange 1124, but may also reduce the structural strength of the end of the ring flange 1124 such that it is easier to deform elastically. In the embodiment, a cross-sectional shape of the ring flange 1124 is isosceles triangle, but the present disclosure is not limited to this embodiment. For example, the cross-sectional shape of the ring flange 1124 may also be right triangle, trapezoid or other shapes, as long as the ring flange 1124 is gradually contracted and extended from the second outer periphery 1122 along the direction away from each of the conductors 120. In the embodiment, the ring flange 1124 further protrudes from the positioning structure 1123, that is the root of the ring flange 1124 sequentially protrudes from the positioning structure 1123, the first outer periphery 1121, and the second outer periphery 1122, so as to ensure that the ring flange 1124 has enough length to perform elastically deformation and abut against the inner wall of the plugging hole 210. Therefore, the male connector and the female connector may perform good sealing dustproof and waterproof effect.

In addition, the positioning slot 220 in the embodiment is the annular groove, and the positioning structure 1123 is the annular convex strip. In other words, the annular groove of the positioning slot 220 surrounds the inner wall of the female connector 200, and the convex strip of the positioning structure 1123 surrounds the first outer periphery 1121 of the male connector 100. Therefore, the male connector 100 may ensure that the positioning structure 1123 may be fixed to the positioning slot 220 when the male connector 100 plugs into the female connector 200 at any angle. However, the present disclosure is not limited to this embodiment. For example, when the plug-in portion 112 is the rectangular body, the positioning structure 1123 may also be four convex blocks arranged on four side planes of the plug-in portion 112, and the positioning slot 220 may also correspondingly be four concave slots. Therefore, the matching form of the positioning structure 1123 and the positioning slot 220 may be modified according to different needs. In addition, the cross-sectional shape of the positioning slot 220 in the embodiment is inwardly concave arcuate slot, and the cross-sectional shape of the positioning structure 1123 is arc convex such that the positioning structure 1123 may be easily fixed into the positioning slot 220, but the present disclosure is not limited to this embodiment.

Details are provided as follows. The plug-in portion 112 further has the stopping ring 1125. The first outer periphery 1121 is connected between the stopping ring 1125 and the second outer periphery 1122, that is the stopping ring 1125 is located between the outer shell 111 and the first outer periphery 1121. Therefore, when the male connector 100 plugs in the female connector 200, the stopping ring 1125 may abut against the female connector 200 to prevent further insertion of the male connector 100, so as to perform a stopping and limiting effect.

In the male connector 100 and the male connector 100 of the connector assembly of the present disclosure, the first outer periphery 1121 and the second outer periphery 1122 are formed on the plug-in portion 112, the first outer periphery 1121 is located between the outer shell 111 and the second outer periphery 1122 , the outer diameter of the first outer periphery 1121 is greater than the outer diameter of the second outer periphery 1122, the positioning structure 1123 is arranged on the first outer periphery 1121, and the ring flange 1124 is arranged on the second outer periphery 1122 and protrudes from the first outer periphery 1121. Therefore, when the male connector 100 plugs in the female connector 200, the male connector 100 has enough space for the ring flange 1124 to deform elastically and bend toward the outer shell 111, so as to perform good sealing dustproof and waterproof effect and fix the positioning structure 1123 to the positioning slot 220 of the female connector 200 to avoid the two from separating.

It shall be understood that the present disclosure may have other types of embodiments, and a person with ordinary skills in the art of the technical field of the present disclosure may make various changes and modifications corresponding to the present disclosure without deviating the principle and substance of the present disclosure; however, such corresponding changes and modification shall be considered to be within the claimed scope of the present disclosure.

What is claimed is:

1. A male connector, used to plug in a female connector, the female connector defining a plugging hole and a positioning slot, the positioning slot located on an inner wall of the plugging hole, the male connector comprising:
an insulating body, comprising an outer shell and a plug-in portion arranged on an end of the outer shell, the plug-in portion comprising a first outer periphery, a second outer periphery, a positioning structure and a ring flange, the first outer periphery located between the outer shell and the second outer periphery, an outer diameter of the first outer periphery being greater than an outer diameter of the second outer periphery, the positioning structure arranged on the first outer periphery, the ring flange arranged on the second outer periphery and protruding from the first outer periphery; and
a plurality of conductors, at least part of each of the conductors arranged in the plug-in portion and surrounded by the second outer periphery;
wherein when the male connector plugs in the female connector, at least part of the plug-in portion and at least part of the conductors are accommodated in the plugging hole, the positioning structure is fixed to the positioning slot, the ring flange elastically bends toward the outer shell and elastically abuts against the inner wall of the plugging hole.

2. The male connector according to claim 1, wherein the ring flange is gradually contracted and extended from the second outer periphery along a direction away from each of the conductors.

3. The male connector according to claim 1, wherein the positioning slot is an annular groove, the positioning structure is an annular convex strip.

4. The male connector according to claim 1, wherein the ring flange further protrudes from the positioning structure.

5. The male connector according to claim 1, wherein the plug-in portion further comprises a stopping ring, the first outer periphery is connected between the stopping ring and the second outer periphery, the stopping ring abuts against the female connector when the male connector plugs in the female connector.

6. A connector assembly, comprising:
a female connector, comprising a plugging hole and a positioning slot, the positioning slot located on an inner wall of the plugging hole; and
a male connector, comprising a plug-in portion, the plug-in portion comprising a first outer periphery, a second outer periphery, a positioning structure and a ring flange, the first outer periphery located on an inner side of the second outer periphery, an outer diameter of the first outer periphery being greater than an outer diameter of the second outer periphery, the positioning structure arranged on the first outer periphery, the ring flange arranged on the second outer periphery and protruding from the first outer periphery;
wherein when the male connector plugs in the female connector, at least part of the plug-in portion is accommodated in the plugging hole, the positioning structure is fixed to the positioning slot, the ring flange elastically bends toward the second outer periphery and elastically abuts against the inner wall of the plugging hole.

7. The connector assembly according to claim 6, wherein the ring flange is gradually contracted and extended from the second outer periphery.

8. The connector assembly according to claim 6, wherein the positioning slot is an annular groove, the positioning structure is an annular convex strip.

9. The connector assembly according to claim 6, wherein the ring flange further protrudes from the positioning structure.

10. The connector assembly according to claim 6, wherein the plug-in portion further comprises a stopping ring, the first outer periphery is connected between the stopping ring and the second outer periphery, the stopping ring abuts against the female connector when the male connector plugs in the female connector.
